(19) United States
(12) Patent Application Publication
(10) Pub. No.: US 2005/0198827 A1
(43) Pub. Date: Sep. 15, 2005

(54) Cutting system construction for electric dry foil shavers

(76) Inventors: Michael Andrew, Monona, WI (US); Robert Garbarino, Killingworth, CT (US)

Correspondence Address: MELVIN I. STOLTZ, ESQ., 51 CHERRY STREET, MILFORD, CT, 06460, US

(21) Appl. No.: 11/077,290

(22) Filed: Mar. 9, 2005

Related U.S. Application Data
(60) Provisional application No. 60/553,245, filed on Mar. 15, 2004.

(51) Int. Cl. B26B 19/14

(52) U.S. Cl. 30/43.6; 30/346.51

(57) ABSTRACT

By providing a substantially continuous, arcuately curved, helical-shaped, spring-like coil or ribbon as the cutting element and securely mounting and retaining the coil/ribbon in a holding member, a substantially improved, highly effective, and long-lasting cutting blade assembly is realized. Furthermore, the cutting blade assembly of this invention is substantially less expensive to manufacture, assemble, and employ in a shaver when compared to prior art constructions. In the preferred construction, an elongated coil holding bar is employed for securely holding and retaining the entire length of the helical-shaped, spring-like coil/ribbon, imparting the required rigidity for enabling the elongated coil/ribbon to function in the desired manner. Furthermore, in the preferred configuration, the elongated bar incorporates a plurality of radially extending panel members mounted to a central hub, with the panel members being constructed for enabling the elongated, helically shaped coil/ribbon to be quickly and easily mounted thereon.

### RELATED APPLICATIONS

This application is related to U.S. Provisional Patent Application Ser. No. 60/553,245, filed Mar. 15, 2004, entitled Improved Cutting System Construction for Electric Dry Foil Shavers.

### TECHNICAL FIELD

This invention relates to electric dry shavers and, more particularly, to improved cutting systems for shavers employing aperture foils.

### BACKGROUND ART

Over the last many years, both men and women have been increasingly drawn to the advantages provided by electric dry shavers. In general, the consuming public has found that the use of razors or other systems is extremely inconvenient for removing or shaving short hair or stubble, as is commonly found in men's beards and women's legs. In addition, with the ever increasing time constraints and commitments individuals typically encounter, a fast and effective shaving system is most desirable.

The discomfort as well as the time consumed in using shaving cream, soaps, and gels in order to provide a medium for which a razor can be used, requires more time and inconvenience than most individuals are willing or capable of incurring. Furthermore, the cost of maintaining a sufficient supply of these products creates an additional burden. Consequently, electric dry shavers have become increasingly popular, as well as battery-operated electric dry shavers which can withstand exposure to moisture, thereby enabling individuals to simultaneously shower as well as shave either beards or legs.

As the popularity of electric dry shavers increased, various product designs and alternate constructions proliferated, in an attempt to improve and enhance the comfort and cutting efficiency of such shavers. However, in spite of these product changes, difficulties have continued to exist in providing optimal results with optimum comfort.

One particular configuration has been found to be extremely efficacious in achieving high quality shaving results, as well as being extremely comfortable to use. This configuration comprises various models of electric dry shavers incorporating a movable cutting blade which cooperates with a thin, flexible mesh screen or apertured foil.

In operation, the cutting blades are rapidly and continuously reciprocatingly moved against one side of the mesh screen or apertured foil, causing the cutting blades to repeatedly cross a plurality of apertures and provide a virtually continuous cutting action in each aperture. Then, by slidingly guiding the other side of the mesh screen or apertured foil over the skin surface to be shaved, the individual hair shafts enter the holes formed in the screen or foil and are cut by the movement of the cutting blades.

Although this dry shaving cutting system has proven to be extremely effective, as compared to other dry shaving products, particular areas of difficulty continue to exist. One such area is found in the expense and difficulty which has continued to exist in manufacturing the cutting blades and the cutting blade assembly.

Typically, the cutting blade assembly employed in most foil shavers comprises a plurality of separate, substantially flat, circular shape cutting elements which are affixed in juxtaposed, spaced, parallel relationship to each other, mounted on an elongated support rod. By placing the elongated support rod and cutting blade assembly in a holding member, which is mounted in the shaver for longitudinal movement along the axis of the elongated rod, the cutting blades are able to reciprocate on the inside surface of the apertured foil or mesh screen for providing the desired cutting action.

Although this construction has become extremely popular and is widely used, the cost of manufacturing each of the plurality of independent cutting blade elements and affixing each of the cutting blade elements to the elongated rod has proven to be an extremely time-consuming and costly component to manufacture and assemble. However, although this problem has existed for many years, prior art constructions have been incapable of achieving an alternate construction which is capable of providing all of the qualities and performance characteristics inherent in this prior art construction.

In addition, in order to assure long term, continuous and effective operation, each cutting blade is constructed with sharp edges in order to provide the desired cutting action as the blade reciprocatingly moves in contact with the mesh screen or apertured foil. However, due to the continuous, reciprocating movement, the edges of the cutting blades become worn, thereby losing their cutting efficiency. As a result, replacement of the entire cutting blade assembly is needed, thereby requiring the consumer to incur additional expenses.

Therefore, it is a principal object of the present invention to provide an enhanced cutting system for electric dry shavers wherein the cutting blade assembly is constructed in a substantially more efficient and effective manner.

Another object to the present invention is to provide an enhanced cutting blade system for electric dry shavers having the characteristic features described above which is highly effective in providing the desired reciprocating inter-engagement with any mesh screen or apertured foil.

Another object of the present invention is to provide an enhanced cutting blade system for electric dry shavers having the characteristic features described above which is capable of being assembled quickly and easily, with a minimum of labor being required.

Another object of the present invention is to provide an enhanced cutting blade system for electric dry shavers having the characteristic features described above which is capable of virtually eliminating any areas which remain unshaven after use.

Another object of the present invention is to provide an enhanced cutting blade system for electric dry shavers having the characteristic features described above wherein the cutting blade element remains sharp, even after long term use.

Other and more specific objects will in part be obvious and will in part appear hereinafter.

### SUMMARY OF THE INVENTION

By employing the present invention, all of the difficulties and drawbacks found with the prior art constructions are completely eliminated and a substantially improved, highly effective, and long-lasting cutting blade assembly is realized. Furthermore, the present invention provides a cutting blade assembly which is substantially less expensive to manufacture, assemble, and employ in a shaver when compared to prior art constructions.

In accordance with the present invention, a unique highly effective, and low-cost cutting blade assembly is attained by employing a substantially continuous, arcuately curved, helical-shaped, spring-like coil or ribbon as the cutting element which is securely mounted and supportingly retained in a holding member. In the preferred construction, an elongated coil holding bar is employed for securely holding and retaining the entire length of the helical-shaped, spring-like coil/ribbon, imparting the required rigidity for enabling the elongated coil/ribbon to function in the desired manner.

In the preferred configuration, the elongated bar incorporates a plurality of radially extending panel members mounted to a central hub, with the panel members being constructed for enabling the elongated, helically shaped coil/ribbon to be quickly and easily mounted thereon. In this way, the cutting blade component is quickly and easily fully assembled and mounted to the shaver in cooperating engagement with the apertured foil or mesh screen thereof.

In this regard, in the preferred construction, the helically shaped coil/ribbon and holding bar assembly is constructed for being securely retained in a blade assembly support member. Typically, the blade assembly support member is constructed for cooperative engagement with the reciprocating drive system of the shaver, as well as for positioning and maintaining the blade assembly in cooperative engagement with the mesh screen or apertured foil.

By employing the construction detailed above, a highly efficient and effective cutting blade assembly is realized which is capable of providing long term, highly effective and efficient cutting capabilities in any desired apertured foil or mesh screen shaver. In addition, the cutting blade assembly is constructed and fully assembled quickly and easily, without requiring numerous small components and tedious, costly assembly time. Consequently, an easily produced, low-cost, cutting blade assembly is achieved without in any way compromising the desired efficacy and efficiency.

A further feature preferably incorporated into the cutting blade assembly of this invention is the construction of the helically shaped coil/ribbon with an outer edge which is constructed for optimizing cutting efficiency. In this regard, in one embodiment, the outer edge of the helically shaped coil/ribbon is constructed with sharp edges for providing the desired cutting efficacy.

In the preferred embodiment, however, the outer edge of the helical shaped coil/ribbon is constructed with inwardly sloping or slanted side edges, providing an outer edge which essentially tapers downwardly as one moves from the outer edge inwardly. In this way, as the outer edge of the helical shaped coil/ribbon wears due to frictional engagement with the aperture foil or mesh screen, the cutting angle formed between the side edge and the terminating outer surface of the helical shaped coil/ribbon remains at a sharp angle, thereby assuring long term, continuous cutting effectiveness.

The invention accordingly comprises an article of manufacture possessing the features, properties, and relation of elements which will be exemplified in the article hereinafter described, and the scope of the invention will be indicated in the claims.

### THE DRAWINGS

For a fuller understanding of the nature and objects of the invention, reference should be had to the following detailed description taken in connection with the accompanying drawings, in which:

FIG. 1 is an exploded perspective view of the cutting blade and support assembly of the present invention;

FIG. 2 is a perspective view of the fully assembled cutting blade assembly and support system of the present invention;

FIG. 3 is a top plan view of the cutting blade assembly and support system of FIG. 2;

FIG. 4 is a side elevation view of the cutting blade assembly and support system of FIG. 2;

FIG. 5 is an end view of the cutting blade assembly and support system of FIG. 4;

FIG. 6 is a cross-sectional end view of the cutting blade assembly and support system taken along the line 6-6 of FIG. 4; and

FIG. 7 is a greatly enlarged, cross-sectional, side elevation view, partially broken away, depicting convolutions of the helically shaped coil/ribbon member securely mounted within notches formed in the coil holding bar, both of which are components of the cutting blade assembly of the present invention.

FIG. 8 is an exploded perspective view, partially broken away, of the cutting blade assembly and support system of the present invention.

### DETAILED DESCRIPTION

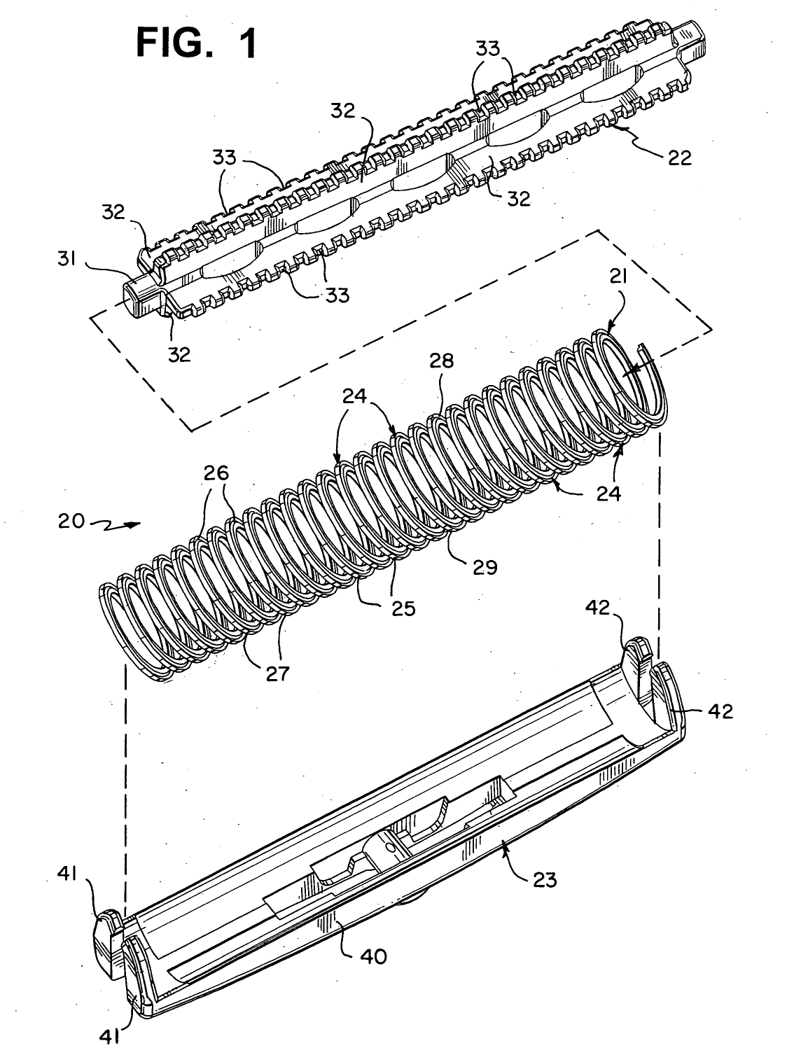

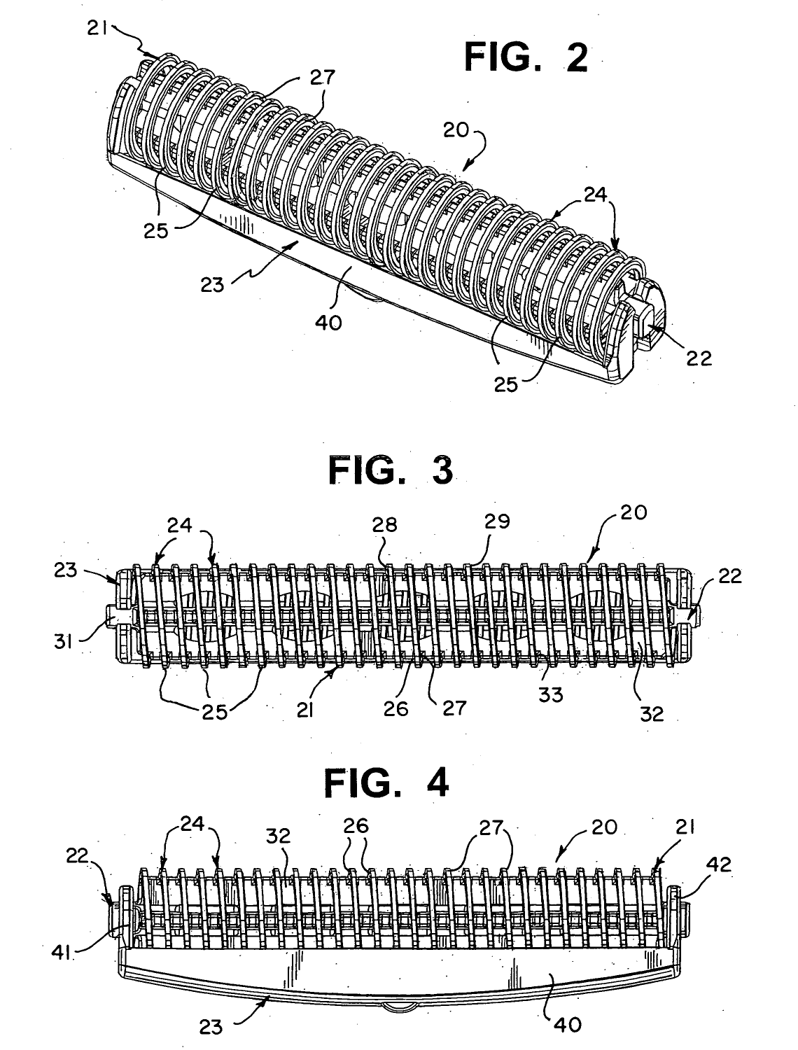

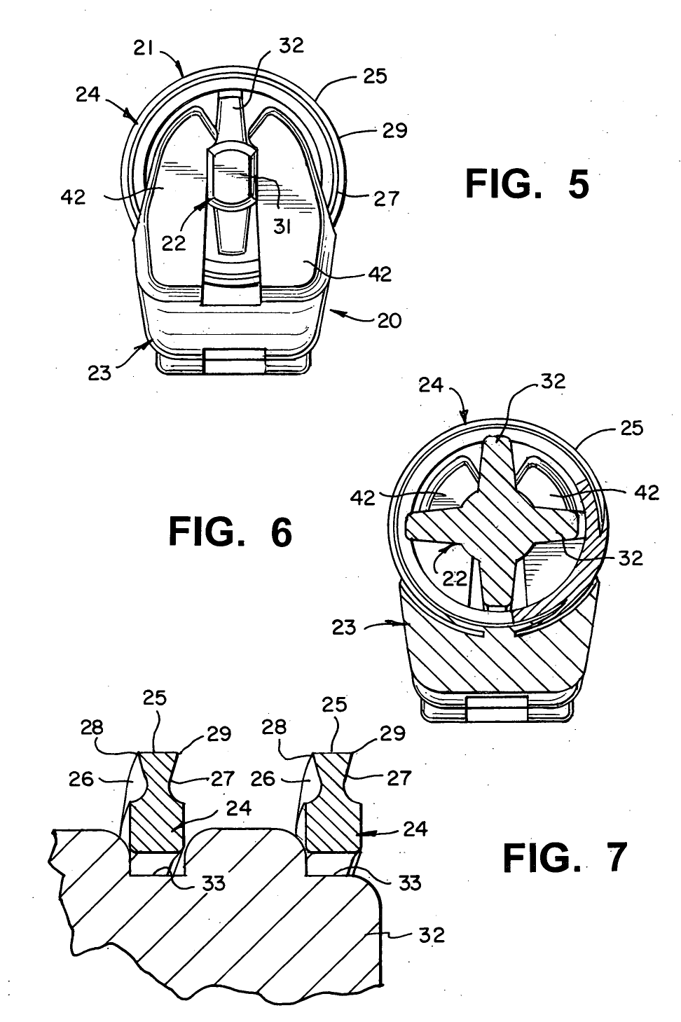

By referring to FIGS. 1-8, along with the following detailed disclosure, the construction of the preferred embodiment of cutting blade assembly and support system 20 of the present invention can best be understood. However, is also to be understood that alternate constructions or variations of this invention can be made without departing from the scope of this invention. Consequently, the following disclosure, along with FIGS. 1-8, are provided for exemplary purposes only and are not intended as a limitation of the present invention.

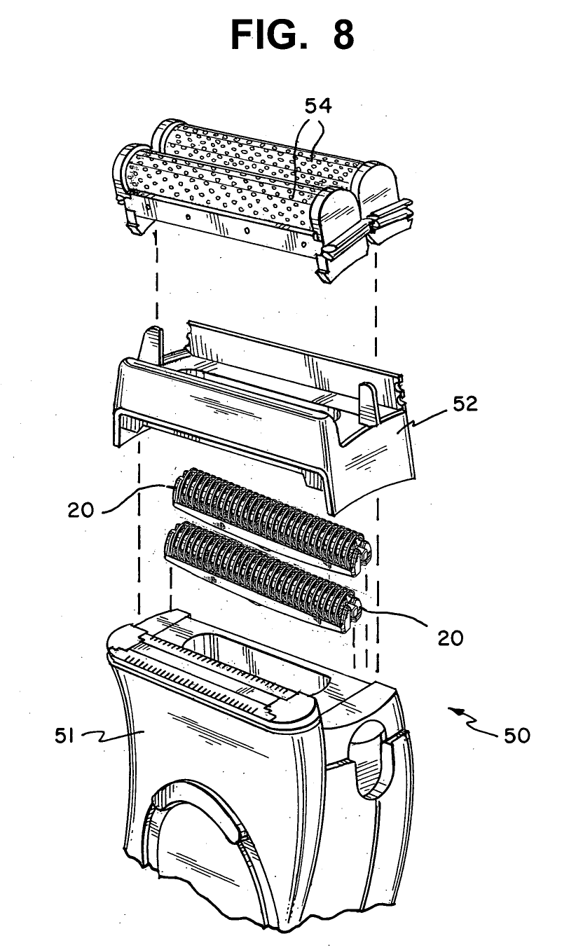

In a typical construction, cutting blade assembly and support system 20 of the present invention is employed in an electric shaver which incorporates an apertured foil or mesh screen in order to achieve the desired cutting action. In this regard, as shown in FIG. 8, a generally conventional electric shaver 50 is shown, for exemplary purposes only, comprising housing 51 to which guard/cover support base 52 is removable and mounted. In addition, two separate and independent cutting blade assemblies and support systems 20 of the present invention are mounted to drive assembly 53, which is constructed for causing cutting blade assemblies and support systems 20 to reciprocatingly move along the central axis thereof in an oscillating, side to side manner.

Furthermore, cutting blade assemblies and support systems 20 are cooperatively associated with apertured foils or mesh screens 54 in order to achieve the desired cutting action. As is well known in the art, each cutting blade assembly and support system 20 is maintained in biasing engagement with one surface of one mesh screen or apertured foil 54, thereby causing each cutting blade assembly and support system 20 to reciprocatingly move in contact with one surface of the mesh screen or apertured foil 54. This oscillating, side to side movement enables the hairs entering through the apertures of the mesh screen or apertured foil 54 to be cut, achieving the desired close, comfortable shave.

In order to attain the desired movement of each cutting blade assembly and support system 20, a motor is contained in housing 51 of shaver 50, which is interconnected with drive assembly 53 in a manner which causes each cutting blade assembly and support system 22 to move in the desired side to side, reciprocating manner. In this way, whenever the motor is activated by the user, the desired cutting action is realized.

The oscillating, side to side movement as well as the overall construction and operation of shavers employing cutting blade assemblies and apertured foils/mesh screens are more fully exemplified in prior art patents, such as U.S. Pat. Nos. 5,185,926 and 6,601,302. For purposes of disclosure, the information contained in these patents regarding the drive systems and the manner in which the cutting blade assemblies and support systems are mounted and driven in combination with the aperture foils and mesh screens is incorporated herein by reference.

As shown in FIGS. 1-6, the preferred embodiment of cutting blade assembly and support system 20 preferably comprises helically shaped, spring-like coil or ribbon member 21, elongated coil holding bar 22, and support carrier 23. As depicted, helically shaped, spring-like coil/ribbon member 21 comprises a generally continuous, arcuately curved, elongated length formed by a plurality of arcuately curved convolutions 24. In addition, each arcuately curved convolution 24 comprises a substantially identical diameter as each adjacent convolution, with convolutions 24 formed along a single, common, elongated central axis.

In addition, each arcuately curved convolution 24 of helically shaped, spring-like coil/ribbon member 21 comprises a substantially flat, outer surface 25. Furthermore, each convolution 24 also comprises side surfaces 26 and 27 extending from outer surface 25, with cutting edge 28 formed at the juncture between side surface 26 and outer surface 25 and cutting edge 29 formed at the juncture between side surface 27 and outer surface 25.

As is evident from the foregoing detailed discussion, by employing this construction, the formation of single, continuous, elongated, helically shaped, spring-like ribbon/coil member 21 simultaneously creates all of the plurality of cutting edges required for cooperative engagement with an apertured foil or mesh screen. As a result, by employing the present invention, the simple formation of elongated, continuous, helically shaped coil/ribbon member 21 eliminates the need for a separate and independent cutting blade to be formed and individually mounted to an elongated support rod. In this way, substantially improved and enhanced manufacturing and production capabilities are realized, with an entire cutting blade assembly being achieved at a substantially reduced cost.

In order to impart sufficient rigidity to elongated, continuous, helically shaped, spring-like ribbon/coil member 21 for enabling coil/ribbon member 21 to be reciprocatingly moved along the inside surface of a cooperating mesh screen or apertured foil, cutting blade assembly and support system 20 preferably comprises coil holding bar 22. In its preferred construction, coil holding bar 22 comprises a longitudinally extending, centrally disposed, elongated mounting post 31, with a plurality of support panels 32 radially extending outwardly from post 31.

As depicted, coil holding bar 22 preferably comprises four separate and independent support panels 32, each of which are mounted to post 31 for radially extending outwardly therefrom at substantially equivalent spaced arcuate distances. As a result, each support panel 32 is positioned substantially 90° from each adjacent panel 32.

In addition, each panel 32 incorporates a plurality of notches 33 formed along the outer edge thereof and extending substantially the entire length of panel 32. As best seen in FIGS. 3-7, notches 33 provide receiving zones within which elongated, helically shaped, spring-like coil/ribbon member 21 is mounted and securely retained on coil holding bar 22.

By employing this construction, it has been found that helically shaped, spring-like, coil/ribbon member 21 is quickly and easily securely mounted in locked engagement with coil holding bar 22 by threadily advancing helically shaped coil/ribbon member 21 onto holding bar 22. This engagement is most easily and conveniently achieved by continuously rotating coil/ribbon member 21 onto coil holding bar 22 for causing convolutions 24 to continuously advance through notches 33 of support panels 32 in response to the rotation of coil/ribbon 21. Once coil/ribbon member 21 is advanced into complete engagement with coil holding bar 22, rotation of coil/ribbon member 21 is stopped and a securely retained, rigid construction is achieved wherein each convolution 24 of coil/ribbon member 20 is secured in notches 33 of support panels 32, and fixedly retained in position for cooperative, sliding, hair-cutting contact with any desired aperture foil or mesh screen.

In completing the construction of the preferred embodiment of the present invention, cutting blade assembly and support system 20 preferably comprises carrier 23 which is constructed for securely holding and supportingly retaining helical, spring-like coil/ribbon member 21 and coil holding bar 22. In its preferred construction, carrier 23 comprises an elongated support base 40 which incorporates a first pair of juxtaposed, spaced, facing, upstanding holding fingers 41-41 formed at one end of support base 40 and a second pair of juxtaposed, spaced, facing, upstanding holding fingers 42-42 formed at the opposed end of base 40.

In its preferred embodiment, upstanding holding fingers 41-41 and 42-42 are constructed for peripherally surrounding and securely engaging both, opposed, terminating ends of mounting post 31 of coil holding bar 22. Although the terminating ends of mounting post 31 may comprise any desired configuration, the substantially rectangular shape depicted in FIGS. 1-5 is preferred, with holding fingers 41-41 and 42-42 being constructed for enabling the rectangular shaped ends of mounting post 31 to be quickly and easily inserted therebetween for secure, retained, locked engagement therewith.

By employing this construction, helical, spring-like, coil/ribbon member 21 and coil holding bar 22 are securely maintained in the precisely desired orientation and position for being reciprocatingly moved along the axis defined by holding bar 22, thereby enabling helical, spring-like coil/ribbon member 21 to be capable of frictionally engaging with the inside surface of any desired apertured foil or mesh screen. In this way, the desired cutting action is achieved with the cutting edges of coil/ribbon member 21 being continuously maintained in the precisely desired frictional engagement with the apertured foil or mesh screen.

Finally, by referring to FIG. 7, the preferred construction of helical, spring-like, coil/ribbon member 21 is clearly depicted. As shown, convolutions 24 of helical coil/ribbon member 21 are securely retained within notches 33 of support panels 32. In addition, cutting edges 28 and 29 of each convolution 24 of helical coil/ribbon member 21 is clearly depicted, with cutting edges 28 being formed at the juncture between outside surface 25 and side surface 26, with cutting edge 29 being formed at the juncture between outside surface 25 and side surface 27.

Furthermore, as clearly depicted in FIG. 7, side surfaces 26 and 27 of each convolution 24 of helical coil/ribbon member 21 are preferably constructed with an inwardly sloping construction, wherein each side surface tapers inwardly towards each other as one moves from outside surface 25 towards notches 33. As detailed above, this construction enables cutting edges 28 and 29 of helical coil/ribbon member 21 to maintain a sharp cutting configuration, even after an extended, longer-term use. By employing sloping or tapering sidewalls 26 and 27, cutting edges 28 and 29 formed with outside surface 25 are maintained sharp, even as outside surface 25 is worn due to frictional engagement with a desired apertured foil or mesh screen.

As is evident from this construction, even though the frictional wear produced on surface 25 by frictional contact with any desired mesh screen or apertured foil causes the overall diameter of convolutions 24 to be reduced, the juncture angle between surface 25 and side surfaces 26 and 27 are maintained at an acute angle due to the slope of surfaces 26 and 27. As a result, cutting edges 28 and 29 are maintained sharp due to this acute angle. In this way, long-term, continuous cutting efficiency is realized and an easily produced and assembled construction is achieved.

It will thus be seen that the objects set forth above, among those made apparent from the preceding description, are efficiently attained and, since certain changes may be made in the above article without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

1. A cutting blade assembly for use in an electric shaver in cooperating relationship with an apertured foil or mesh screen, said cutting blade assembly comprising:
A. a support carrier constructed for mounted engagement with a motor-driven drive member of the shaver,
B. an elongated holding bar incorporating
a. mounting posts positioned for secure engagement with the support carrier, and
b. a plurality of receiving zones formed along the length thereof; and
C. an elongated, helically shaped coil/ribbon supportingly mounted to the holding bar in secure engagement with the plurality of receiving zones and positioned for enabling the outer edge thereof to cooperatingly engage a surface of the apertured foil/mesh screen;
whereby movement of the cutting blade assembly in cooperating relationship with the apertured foil/mesh screen enables hairs entering the aperture foil/mesh screen to be cut in the desired manner.

2. The cutting blade assembly defined in claim 1, wherein the elongated, helically shaped coil/ribbon is further defined as comprising a plurality of continuous, arcuately curved convolutions.

3. The cutting blade assembly defined in claim 2, wherein each of the convolutions of the helically shaped coil/ribbon are further defined as comprising substantially identical diameters.

4. The cutting blade assembly defined in claim 1, wherein the helically shaped coil/ribbon is further defined as comprising a substantially flat outer edge.

5. The cutting blade assembly defined in claim 4, wherein the helically shaped coil/ribbon is further defined as comprising sloping side walls extending from the substantially flat outer edge, with the sloping side walls extending inwardly on both sides thereof.

6. The cutting blade assembly defined in claim 5, wherein the juncture between the sloping side walls and the substantially flat outer surface forms a sharp cutting edge which extends substantially the entire length of the helically shaped coil/ribbon.

7. The cutting blade assembly defined in claim 1, wherein said elongated holding bar is further defined as comprising a plurality of elongated panels cooperatively associated with each other, with each of said panels incorporating a plurality of notches formed along a terminating end thereof.

8. The cutting blade assembly defined in claim 7, wherein said elongated holding bar is further defined as comprising an elongated, centrally mounted shaft, and four panels extending from said shaft with each of said panels being mounted substantially perpendicularly to each other.

9. The cutting blade assembly defined in claim 8, wherein said shaft is further defined as incorporating mounting posts formed at opposed end thereof, with said mounting posts being constructed for mating, locking engagement with the support carrier.

10. The cutting blade assembly defined in claim 9, wherein said support carrier is further defined as comprising an elongated support base constructed for mounted engagement with the drive member of the shaver and a pair of upstanding end walls formed at the terminating ends of the support base with each of said walls incorporating a receiving slot for locking, mounted engagement with the mounting posts of the holding bar.

11. The cutting blade assembly defined in claim 10, wherein the mounting posts formed on the shaft of the elongated holding bar are further defined as being coaxially aligned with the central axis of the shaft, extending outwardly beyond the terminating edges of the panels.

12. The cutting blade assembly defined in claim 11, wherein said holding bar is further defined as comprising a plurality of notches cooperatively associated with each other for securely retaining and maintaining the elongated, helically shaped coil/ribbon in secure mounted engagement therewith.

13. The cutting blade assembly defined in claim 12, wherein said elongated holding bar is further defined as being constructed for enabling the helically shaped coil/ribbon to be securely mounted thereto by arcuately rotating the helically shaped coil/ribbon into engagement with the plurality of notches formed on the holding bar.

14. An electric dry shaver comprising:
A. a housing incorporating drive means for reciprocatingly moving a cutting blade assembly;
B. at least one arcuately curved, apertured foil member removably mounted to the housing;
C. at least one cutting blade assembly mounted to the housing for reciprocating, side-to-side movement and sliding, frictional interengagement with one surface of the arcuately curved, apertured foil member, said cutting blade assembly comprising
a. a support carrier constructed for mounted engagement with the motor-driven drive member of the shaver,
b. an elongated holding bar incorporating
1. mounting posts positioned for secure engagement with the support carrier, and
2. a plurality of receiving zones formed along the length thereof; and
c. an elongated, helically shaped coil/ribbon supportingly mounted to the holding bar in secure engagement with the plurality of receiving zones and positioned for enabling the outer edge thereof to cooperatingly engage a surface of the apertured foil/mesh screen;
whereby a uniquely constructed shaver is realized which incorporates a cost effective cutting blade construction capable of providing efficient and comfortable hair cutting results.

15. The electric dry shaver defined in claim 14, wherein the elongated, helically shaped coil/ribbon of the cutting blade assembly is further defined as comprising a plurality of continuous, arcuately curved convolutions.

16. The electric dry shaver defined in claim 15, wherein each of the convolutions of the helically shaped coil/ribbon are further defined as comprising substantially identical diameters.

17. The electric dry shaver defined in claim 16, wherein the helically shaped coil/ribbon is further defined as comprising a substantially flat outer edge.

18. The electric dry shaver defined in claim 17, wherein the helically shaped coil/ribbon is further defined as comprising sloping side walls extending from the substantially flat outer edge, with the sloping side walls extending inwardly on both sides thereof.

19. The electric dry shaver defined in claim 18, wherein the juncture between the sloping side walls and the substantially flat outer surface forms a sharp cutting edge which extends substantially the entire length of the helically shaped coil/ribbon.
